(19) United States
(12) Patent Application Publication
(10) Pub. No.: US 2022/0082694 A1
(43) Pub. Date: Mar. 17, 2022

(54) DISTANCE MEASURING DEVICE AND DISTANCE MEASURING METHOD

(71) Applicant: KABUSHIKI KAISHA TOSHIBA, Tokyo (JP)

(72) Inventors: Hiroshi Kubota, Yokohama Kanagawa (JP); Nobu Matsumoto, Ebina Kanagawa (JP); Hisaaki Katagiri, Kawasaki Kanagawa (JP)

(73) Assignee: KABUSHIKI KAISHA TOSHIBA, Tokyo (JP)

(21) Appl. No.: 17/462,674

(22) Filed: Aug. 31, 2021

(30) Foreign Application Priority Data
Sep. 17, 2020 (JP) 2020-156727

(51) Int. Cl. G01S 17/10; G01S 7/481; G01S 7/4865; G01S 17/931

(52) U.S. Cl. CPC G01S 17/10; G01S 7/4814; G01S 17/931; G01S 7/4816; G01S 7/4865

(57) ABSTRACT

A distance measuring device according to the present embodiment comprises an averaging processor, a detector, and a distance measuring circuit. The averaging processor is configured to average a digital signal obtained by digitizing reflected light of laser light and generate a time-series luminance signal. The detector is configured to detect a rise time at which the time-series luminance signal reaches a threshold. The distance measuring circuit is configured to measure a distance to an object based on a time difference between the rise time and a radiation timing of the laser light.

### CROSS-REFERENCE TO RELATED APPLICATIONS

This application is based upon and claims the benefit of priority from the prior Japanese Patent Application No. 2020-156727, filed on Sep. 17, 2020 the entire contents of which are incorporated herein by reference.

### FIELD

Embodiments of the present invention relate to a distance measuring device and a distance measuring method.

### BACKGROUND

There is known a distance measuring technique called LIDAR (Light Detection and Ranging). This distance measuring technique radiates laser light to a measurement object and converts the intensity of reflected light reflected from the measurement object to a time-series measurement signal based on a sensor output. Accordingly, the distance to the measurement object is measured based on a time difference between a time of emission of the laser light and a time at which the reflected light is received by a sensor.

However, saturation of a time-series luminance signal frequently occurs as the number of photons input to the sensor per unit time increases, thus resulting in reduction of measurement accuracy.

### BRIEF DESCRIPTION OF THE DRAWINGS

FIG. 1 is a diagram illustrating an overall schematic configuration of a driver assistance system according to an embodiment;

FIG. 2 is a diagram illustrating a configuration example of a distance measuring device according to a first embodiment;

FIG. 3 is a diagram schematically illustrating an emission pattern of a light source in one frame;

FIG. 4 is an enlarged schematic diagram illustrating positions irradiated with laser light on a measurement object in one frame;

FIG. 5 is an enlarged schematic diagram illustrating irradiated positions on the measurement object, which are irradiated in an order different from that in the example in FIG. 4;

FIG. 6 is a diagram illustrating an example in which a vertical line is simultaneously irradiated by using a one-dimensional laser light source;

FIG. 7A is a diagram illustrating an example in which each vertical line in each row is simultaneously irradiated by using the one-dimensional laser light source;

FIG. 7B is a diagram illustrating an example of a polygon mirror;

FIG. 8 is a diagram illustrating an example in which a measurement object is present in a partial region in a radiation range;

FIG. 9 is a diagram illustrating an example of a time-series luminance signal in a current frame;

FIG. 10 is a block diagram illustrating a configuration of a signal processor;

FIG. 11A is a time-series luminance signal B in the current frame;

FIG. 11B is a time-series luminance signal B corresponding to an upper row in the same frame;

FIG. 11C is an average value B2 of the time-series luminance signal B in the current frame and the time-series luminance signal B corresponding to the upper row;

FIG. 12A is an explanatory diagram of a processing example by a rise detector and an interpolation processor;

FIG. 12B is a flowchart illustrating a processing example by the distance measuring device according to the present embodiment;

FIG. 13 is a block diagram illustrating a configuration of a signal processor according to a second embodiment;

FIG. 14 is a block diagram illustrating a configuration example of a detector;

FIG. 15 is a diagram schematically illustrating an effect of subtraction in a case where floor noise is relatively large;

FIG. 16 is a diagram illustrating an example of a processing result in a case where peak pattern filtering is applied;

FIG. 17 is a diagram illustrating an example of peak pattern filtering;

FIG. 18 is a diagram illustrating an example of rise times and fall times;

FIG. 19 is a diagram illustrating a time-series luminance signal generated by a bottom calculator;

FIG. 20 is a diagram schematically illustrating a threshold obtained as a result of subtraction of an average value from a maximum value;

FIG. 21 is a diagram illustrating a configuration of a distance measuring device according to a third embodiment; and

FIG. 22 is a diagram schematically illustrating timings of even-numbered emission and odd-numbered emission and superposing of time-series luminance signals of those emissions.

### DETAILED DESCRIPTION

Embodiments of the present invention have been made in view of the above circumstance and aim to provide a distance measuring device and a distance measuring method that can perform stable distance measurement even when a time-series luminance signal is saturated.

A distance measuring device according to the present embodiment comprises an averaging processor, a detector, and a distance measuring circuit. The averaging processor is configured to average a digital signal obtained by digitizing reflected light of laser light and generate a time-series luminance signal. The detector is configured to detect a rise time at which the time-series luminance signal reaches a threshold. The distance measuring circuit is configured to measure a distance to an object based on a time difference between the rise time and a radiation timing of the laser light.

The distance measuring device and the distance measuring method according to the embodiment of the present invention will be explained below in detail with reference to the accompanying drawings. The following embodiments are merely examples of the embodiments of the present invention, and the present invention is not to be construed as being limited to the embodiments. Identical portions or portions having similar functions in the drawings referred to in the embodiments are denoted by identical or like signs and redundant explanations thereof are omitted in some cases. Further, dimensional proportions of the drawings may be different from those of actual ones or a part of the configuration may be omitted from the drawings in some cases for convenience of explanations.

### First Embodiment

A distance measuring device according to the present embodiment aims to detect a rise time at which a time-series luminance signal that is based on a digital signal obtained by digitizing reflected light of laser light reaches a first threshold, thereby detecting a timing of return of the reflected light from an object more stably, even when a sensor output is saturated. The device is described in more detail below.

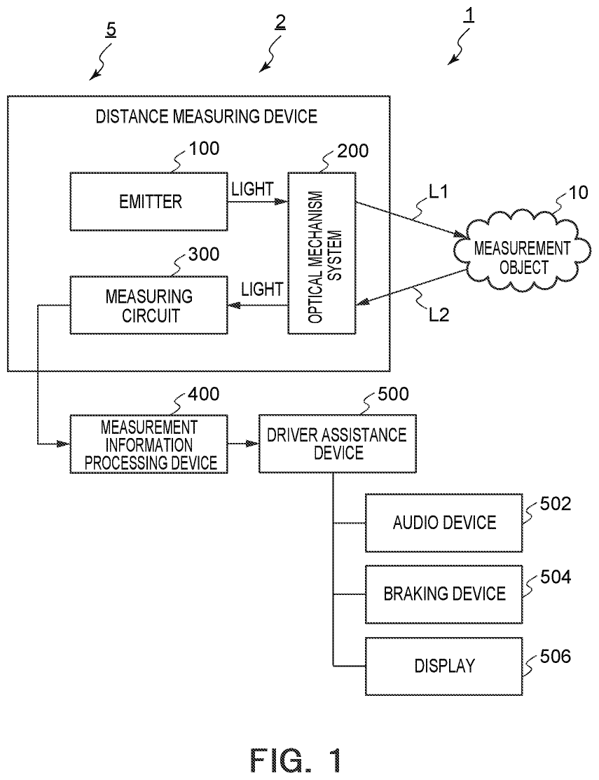

FIG. 1 is a diagram illustrating an overall schematic configuration of a driver assistance system according to the present embodiment. A driver assistance system 1 assists a driver based on a range image, as illustrated in FIG. 1. The driver assistance system 1 is configured to include a distance measuring system 2, a driver assistance device 500, an audio device 502, a breaking device 504, and a display 506. The distance measuring system 2 generates a range image and a speed image of a measurement object 10 and includes a distance measuring device 5 and a measurement information processing device 400.

The distance measuring device 5 measures a distance to the measurement object 10 and a relative speed using a scanning method and a TOF (Time Of Flight) method. More specifically, the distance measuring device 5 is configured to include an emitter 100, an optical mechanism system 200, and a measuring circuit 300.

The emitter 100 intermittently emits laser light L1. The optical mechanism system 200 radiates the laser light L1 emitted by the emitter 100 to the measurement object 10 and causes reflected light L2 of the laser light L1 reflected from the measurement object 10 to be incident on the measuring circuit 300. Here, laser light means light in which waves have the same phase and the same frequency. The reflected light L2 means light traveling to a predetermined direction in scattered light of the laser light L1.

The measuring circuit 300 measures a distance to the measurement object 10 based on the reflected light L2 received through the optical mechanism system 200. That is, the measuring circuit 300 measures a distance to the measurement object 10 based on a time difference between a time at which the emitter 100 radiates the laser light L1 to the measurement object 10 and a time at which the reflected light L2 is measured. Further, the measuring circuit 300 measures a relative speed based on change of distance to the measurement object 10 per unit time. A speed is obtained by subtracting the speed of the distance measuring device 5 from the relative speed. That is, when the distance measuring device 5 is stopped, the relative speed is the speed. Therefore, the relative speed, the speed, a difference between the distance values, and the like may be called speed-related values in some cases in the present embodiment.

The measurement information processing device 400 performs noise reduction processing and outputs range image data and relative speed data based on the distances to a plurality of measurement points on the measurement object 10. A part or the whole of the measurement information processing device 400 may be incorporated in the housing of the distance measuring device 5.

The driver assistance device 500 assists driving of a vehicle in accordance with an output signal of the measurement information processing device 400. The audio device 502, the braking device 504, and the display 506, for example, are connected to the driver assistance device 500.

The audio device 502 is, for example, a speaker and is arranged at a position audible from a driver's seat in a vehicle. The driver assistance device 500 causes the audio device 502 to generate phonetic sound such as “5 meters to an object” based on an output signal of the measurement information processing device 400. Accordingly, it is possible to call the driver's attention by causing the driver to hear the phonetic sound, for example, also in a case where the driver becomes less attentive.

The braking device 504 is, for example, an auxiliary brake. The driver assistance device 500 causes the braking device 504 to brake the vehicle, for example, when an object approaches a predetermined distance, for example, 3 meters, based on the output signal of the measurement information processing device 400.

The display 506 is, for example, a liquid crystal monitor. The driver assistance device 500 displays an image on the display 506 based on the output signal of the measurement information processing device 400. Accordingly, it is possible to grasp external information more accurately by referring to the image displayed on the display 506, for example, even when there is backlight.

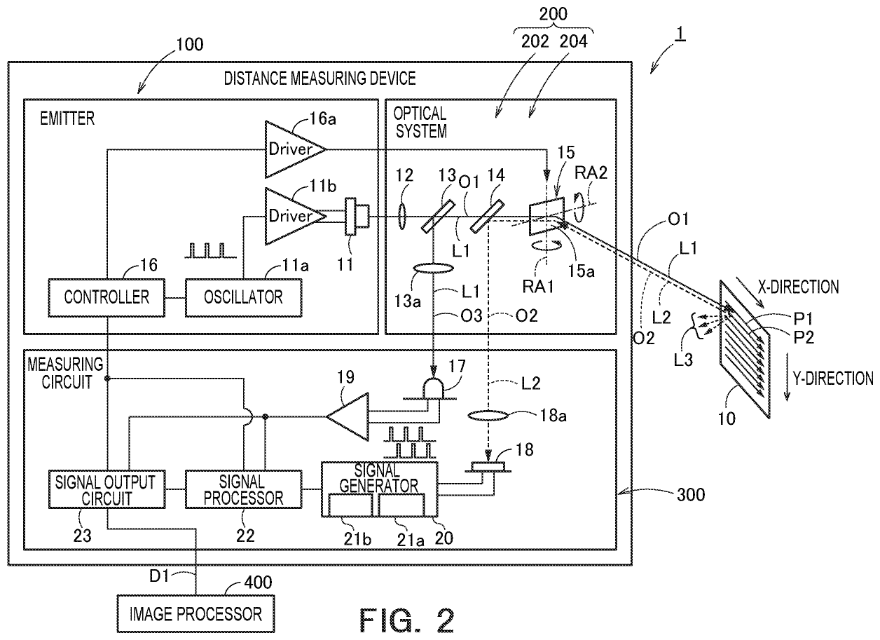

Next, a more detailed configuration example of the emitter 100, the optical mechanism system 200, and the measuring circuit 300 of the distance measuring device 5 according to the present embodiment is described with reference to FIG. 2. FIG. 2 is a diagram illustrating a configuration example of the distance measuring device 5 according to the first embodiment. As illustrated in FIG. 2, the distance measuring device 5 is configured to include the emitter 100, the optical mechanism system 200, the measuring circuit 300, and the measurement information processing device 400. Here, light scattered in a predetermined direction in scattered light L3 is called the reflected light L2. The block diagram in FIG. 2 illustrates an example of signals, and the order and the wiring are not limited thereto.

The emitter 100 includes a light source 11, an oscillator 11a, a first driver 11b, a controller 16, and a second driver 16a.

The optical mechanism system 200 includes a radiation optical system 202 and a light-receiving optical system 204. The radiation optical system 202 includes a lens 12, a first optical element 13, a lens 13a, and a mirror (a reflecting device) 15.

The light-receiving optical system 204 includes a second optical element 14 and the mirror 15. That is, the radiation optical system 202 and the light-receiving optical system 204 share the mirror 15.

The measuring circuit 300 includes a photodetector 17, a sensor 18, a lens 18a, a first amplifier 19, and a first distance measuring circuit 300a. Although the mirror 15 is used as an existing method of performing scanning with light in this example, there is known a method of rotating the distance measuring device 5 (hereinafter, “rotating method”) other than the method of using the mirror 15. Another existing scanning method is an OPA (Optical Phased array) method. Since the present embodiment does not depend on how to perform scanning with light, scanning with light may be performed by the rotating method or the OPA method.

The oscillator 11a of the emitter 100 is controlled by the controller 16 to generate a pulse signal. The first driver 11b drives the light source 11 based on the pulse signal generated by the oscillator 11a. The light source 11 is a laser light source such as a laser diode, and intermittently emits the laser light L1 by being driven by the first driver 11b.

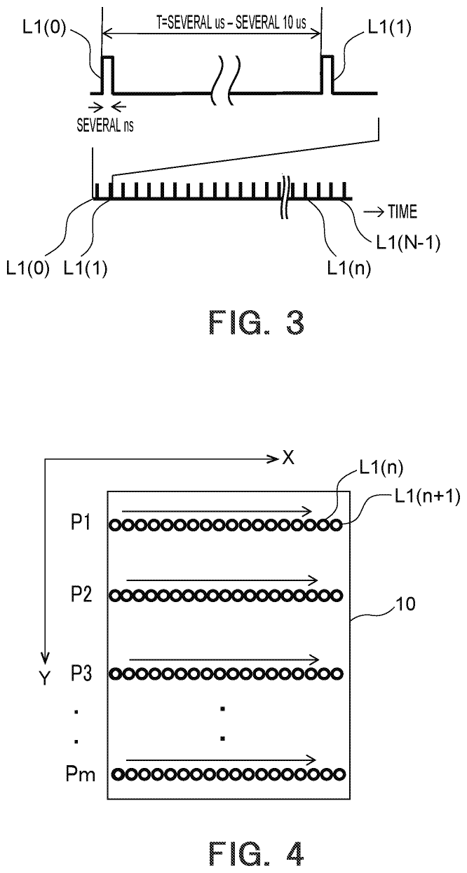

Next, an emission pattern of the light source 11 in one frame is described with reference to FIG. 3. Here, a frame means a combination of emission of the laser light L1 that is repeated periodically. FIG. 3 is a diagram schematically illustrating an emission pattern of the light source 11 in one frame. In FIG. 3, the horizontal axis represents time, and the vertical axis represents an emission timing of the light source 11. The upper diagram is an enlarged view of a portion in the lower diagram. As illustrated in FIG. 3, the light source 11 intermittently and repeatedly emits laser light L1(n) (0≤n<N) at an interval of T that is several microseconds to dozens of microseconds, for example. In this description, the laser light L1 emitted by n-th emission is represented as L1(n). N represents the number of times of emission of the laser light L1(n) radiated for measurement of the measurement object 10 in one frame. After radiation of one frame is finished, radiation of the next frame is started from L1(0).

As illustrated in FIG. 2, the light source 11, the lens 12, the first optical element 13, the second optical element 14, and the mirror 15 are arranged on an optical axis O1 of the radiation optical system 202 in this order. Accordingly, the lens 12 collimates the laser light L1 emitted intermittently and directs the collimated light to the first optical element 13.

The first optical element 13 transmits the laser light L1 and makes a portion of the laser light L1 incident on the photodetector 17 along an optical axis O3. The first optical element 13 is, for example, a beam splitter.

The second optical element 14 further transmits the laser light L1 transmitted through the first optical element 13 and makes the transmitted light incident on the mirror 15. The second optical element 14 is, for example, a half mirror.

The mirror 15 has a reflection surface 15a that reflects the laser light L1 intermittently emitted from the light source 11. The reflection surface 15a is turnable about each of two turning axis lines RA1 and RA2 crossing each other, for example. Accordingly, the mirror 15 changes the direction of radiation of the laser light L1 periodically.

The controller 16 has, for example, a CPU (Central Processing Unit) and controls the second driver 16a to continuously change the angle of inclination of the reflection surface 15a. The second driver 16a drives the mirror 15 in accordance with a driving signal supplied from the controller 16. That is, the controller 16 controls the second driver 16a to change the radiation direction of the laser light L1.

Next, the radiation direction of the laser light L1 in one frame is described with reference to FIG. 4. FIG. 4 is an enlarged schematic diagram illustrating positions irradiated with the laser light L1 on the measurement object 10 in one frame. As illustrated in FIG. 4, the reflection surface 15a (FIG. 2) changes the radiation direction for each laser light L1 to radiate the light onto discrete positions along a corresponding one of straight paths P1 to Pm (m is a natural number of 2 or more) on the measurement object 10 which are substantially parallel to each other. In this manner, the distance measuring device 5 according to the present embodiment performs radiation to the measurement object 10 once while changing a radiation direction O(n) (0≤n<N) of the laser light L1(n) (0≤n<N) for each frame f(m) (0≤n<M). Here, the radiation direction of the laser light L1(n) is described as O(n). That is, in the distance measuring device 5 according to the present embodiment, the laser light L1(n) is radiated once to the radiation direction θ(n). Since the radiation direction θ(n) (0≤n<N) is the same between frames, the radiation direction θ(n) (0≤n<N) in the m-th frame and the radiation direction θ(n) (0≤n<N) in the (m−1)th frame match each other.

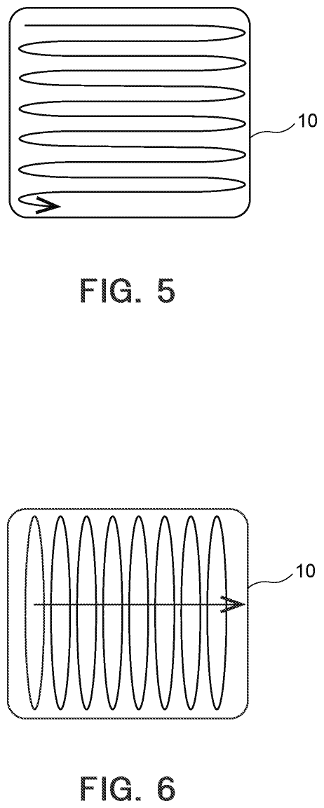

Next, an example of radiation of the laser light L1 different from the example in FIG. 4 is described with reference to FIGS. 5 to 7A.

FIG. 5 is an enlarged schematic diagram illustrating irradiated positions on the measurement object 10, which are irradiated in an order different from that in the example in FIG. 4. FIG. 6 is a diagram illustrating an example in which a vertical line is simultaneously irradiated by using an emission optical system that emits light spreading in a vertical direction.

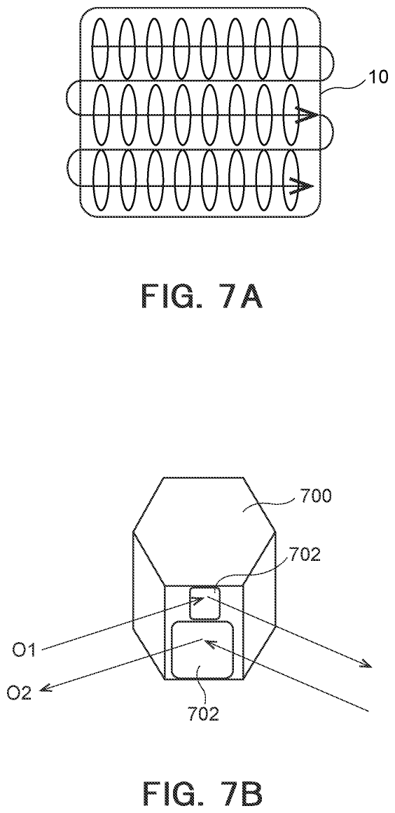

FIG. 7A is a diagram illustrating an example in which each vertical line in each row is simultaneously irradiated by using an emission optical system that emits light spreading in the vertical direction.

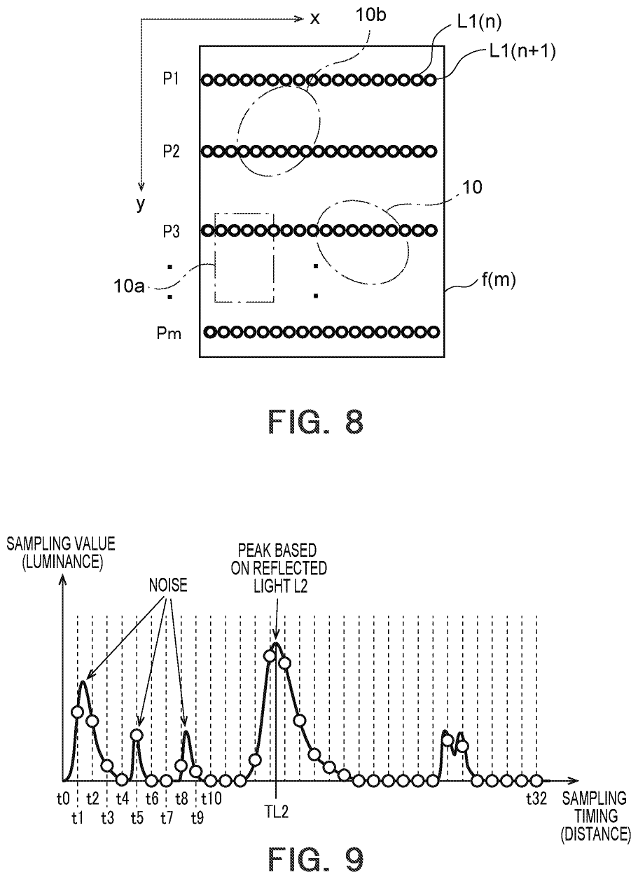

While the laser light L1(n) according to the present embodiment may be radiated to points one by one as illustrated in FIGS. 4 and 5 as explained above, it is not limited thereto and may be radiated to the points simultaneously. For example, positions on a vertical line may be simultaneously irradiated by using a one-dimensional laser light source as illustrated in FIG. 6 or FIG. 7A. Here, the measurement object 10 is schematically illustrated as being a flat plate in FIG. 8 for facilitating explanations. However, the measurement object 10 is, for example, an automobile in actual measurement.

Scanning as illustrated in FIG. 7A can be performed by means of, for example, a polygon mirror having different tilt angles as illustrated in FIG. 7B. FIG. 7B is a diagram illustrating an example of a polygon mirror 700 arranged, for example, at the position of the mirror 15 (FIG. 2). Radiation surfaces 701 in FIG. 7B are different from each other in tilt angles. Accordingly, when the polygon mirror 700 rotates, the radiation direction of radiated laser light is changed to the perpendicular direction. In the polygon mirror in FIG. 7B, a portion on which emitted light is incident and a light-receiving surface are separated from each other on the mirror (a separation optical system), and the second optical element 14 in FIG. 2 is not required.

Further, scanning as illustrated in FIG. 7A can be also performed by means of a rotating mirror, a two-axis MEMS mirror, or the like. Although the above-described scanning method is mechanical, there is known an OPA (Optical Phased array) method as another existing scanning method. Since the present embodiment does not depend on how to perform scanning with light, scanning with light may be performed by either the mechanical method or the OPA method.

Next, an example in which the measurement object 10 and another reflector are present in a radiation range of the laser light L1(n) in one frame is described with reference to FIG. 8.

FIG. 8 is a diagram illustrating an example in which the measurement object 10 is present in a partial region in a radiation range. As illustrated in FIG. 8, in a case where the measurement object 10 is present in the distance, the measurement object 10 is present in a partial region in a radiation range of the laser light L1. For example, a building 10a, another automobile 10b, a person, a road, or the sky is present out of the range of the measurement object 10. Therefore, when a reflecting object to which the laser light L1(n) (0≤n<N) is radiated is different, the distance to be measured is also different.

As illustrated in FIG. 2, the reflection surface 15a of the mirror 15, the second optical element 14, the lens 18a, and the sensor 18 are arranged on an optical axis O2 of the light-receiving optical system 204 in the order of incidence of the reflected light L2. Here, the optical axis O1 is a focal axis of the lens 12 which passes through the center of the lens 12. The optical axis O2 is a focal axis of the lens 18a which passes through the center of the lens 18a.

The reflection surface 15a makes the reflected light L2 in the scattered light L3 scattered from the measurement object 10, which travels along the optical axis O2, incident on the second optical element 14. The second optical element 14 changes the traveling direction of the reflected light L2 reflected by the reflection surface 15a and makes the reflected light incident on the lens 18a of the measuring circuit 300 along the optical axis O2. The lens 18a causes the reflected light L2 incident thereon along the optical axis O2 to converge on the sensor 18.

Meanwhile, the traveling direction of light in the scattered light L3, which is reflected to a direction different from the direction of the laser light L1, is deviated from the optical axis O2 of the light-receiving optical system 204. Therefore, light in the scattered light L3, which is reflected to the direction different from the optical axis O2, is incident on a position deviated from an incident surface of the sensor 18 even when it is incident within the light-receiving optical system 204. On the other hand, ambient light such as sunlight scattered by a certain object includes light traveling along the optical axis O2, and such light is incident on the incident surface of the sensor 18 at random to become random noise.

Although optical paths of the laser light L1 and the reflected light L2 are illustrated as being separated from each other in FIG. 2 for the sake of clarity, they may overlap each other in actual practice. An optical path of the center of the beam of the laser light L1 is illustrated as the optical axis O1. Similarly, an optical path of the center of the beam of the reflected light L2 is illustrated as the optical axis O2.

The sensor 18 is configured by photomultipliers (SiPM: Silicon Photomultipliers), for example. The photomultiplier is a photon counting device in which a plurality of single photon avalanche diodes (SPADs) are integrated. The photomultiplier can detect weak light at a photon counting level. Here, the dynamic range of the SiPM depends on the number of integrated SPADs per pixel (the number of SPADs/pixel). The SiPM has an advantage that the detection capability, that is, the sensitivity is higher as compared with an APD, for example, but has a disadvantage that the dynamic range is smaller. SiPMs include a 1D SiPM in which SPADs are integrated in one vertical line, that is, one-dimensionally and a 2D SiPM in which SPADs are integrated two-dimensionally vertically and horizontally. In the 2D SiPM, the number of SPADs/pixel becomes small because of size restriction, and in particular the dynamic range is reduced in many cases.

More specifically, the sensor 18 converts the reflected light L2 received through the light-receiving optical system 204 to an electric signal. A light-receiving element of the sensor 18 is configured by Geiger-mode avalanche photodiodes (APDs) and SPADs having quenching resistance connected in parallel.

An avalanche photodiode is a light-receiving element in which the light-receiving sensitivity is increased by using a phenomenon called avalanche multiplication. The avalanche photodiode used in the Geiger mode is generally used together with a quenching element (described later) and is called a single-photon avalanche diode (SPAD). The avalanche photodiode using silicon as its material is sensitive to light having a wavelength of 200 nm to 1000 nm, for example.

Although the sensor 18 according to the present embodiment is configured by silicon photomultipliers, it is not limited thereto. For example, the sensor 18 may be configured by arranging photodiodes, avalanche diodes (ABDs: avalanche breakdown diodes), and photomultipliers using compound semiconductor as its material. The photodiode is made of semiconductor serving as a photodetector, for example. The avalanche diode is a diode in which the light-receiving sensitivity is increased by avalanche breakdown caused by a specific reverse voltage.

As illustrated in FIG. 2, the distance measuring circuit 300 measures a distance to the measurement object 10 based on a time-series luminance signal B obtained by performing analog-to-digital conversion for a measurement signal converted from the reflected light L2 of the laser light L1. The distance measuring circuit 300 includes a signal generator 20, a signal processor 22, and an output interface 23.

The signal generator 20 converts an electric signal output from the sensor 18 to a time-series luminance signal at a predetermined sampling interval. The signal generator 20 includes an amplifier 21a and an AD converter 21b. The amplifier 21a amplifies an electric signal based on the reflected light L2, for example. More specifically, a transimpedance amplifier (TIA) that converts a current signal of the sensor 18 to a voltage signal and amplifies the voltage signal, for example, is used as the amplifier 21a.

The AD converter (ADC: Analog to Digital Converter) 21b samples a measurement signal amplified by the amplifier 21a at a plurality of sampling timings to convert it to a digital time-series luminance signal corresponding to the radiation direction of the laser light L1. That is, the AD converter 21b samples the measurement signal amplified by the amplifier 21a. The digital signal obtained by sampling the electric signal based on the reflected light L2 at a predetermined sampling interval in this manner is referred to as a time-series luminance signal. That is, the time-series luminance signal is a series of values obtained by sampling temporal change of the reflected light L2 at the predetermined sampling interval.

Next, an example of a time-series luminance signal B(m, t) (t0≤t≤t32) in a current frame f(m) is described with reference to FIG. 9. FIG. 9 is a diagram illustrating an example of the time-series luminance signal B(m, t) (t0≤t≤t32) in the current frame f(m). That is, FIG. 9 illustrates an example of sampling values of the measurement signal sampled by the signal generator 20 (FIG. 2). The horizontal axis in FIG. 9 represents a sampling timing, and the vertical axis represents a sampling value of the time-series luminance signal B(m), that is, a luminance value.

For example, a time obtained by adding a blanking period to each of sampling timings t0 to t32 corresponds to an elapsed time T (FIG. 3) from radiation of the laser light L1(n) to radiation of the next laser light L1(n+1). A peak in FIG. 9 is a sampling value based on the reflected light L2. For example, a sampling timing TL2 indicating the peak maximum value corresponds to twice the distance to the measurement object 10. A peak means a point that represents the maximum value in each upward convex region of a time-series signal in which a value changes with time. That is, in a case where there are a plurality of upward convex regions, there are also a plurality of peaks. For example, a peak means a point that represents the maximum value in each upward convex region of the time-series luminance signal B(m, t) (t0≤t≤t32).

More specifically, the distance can be obtained by an equation “distance=speed of light×(sampling timing TL2-timing of detection of laser light L1 by photodetector 17)/2”. The sampling timing is an elapsed time from a start time of emission of the laser light L1.

Here, m (0≤m<M) of a time-series luminance signal B(m, t, x, y) represents the number of a frame f, and a coordinate (x, y) represents a coordinate determined based on the radiation direction of the laser light L1(n) (0≤n<N). That is, the coordinate (x, y) corresponds to a coordinate when a range image and a speed image of the current frame f(m) are generated. More specifically, it is assumed that the coordinate (0, 0) corresponding to laser light L1(0) is the origin and the number of times of radiation of the laser light L1(n) (0≤n<N) in the horizontal direction is HN, as illustrated in FIG. 8. It is also assumed that a function [β] is a function representing the maximum integer equal to or smaller than β. In this case, x=n−[n÷HN]×HN and y=[n÷HN]. The number of sampling timings and the time range in which sampling is performed, which are illustrated, are merely an example and may be changed. Further, accumulation of luminance signals of close coordinates may be used as the time-series luminance signal B(m, t, x, y). For example, luminance signals in a coordinate range of 2×2, 3×3, or 5×5 may be accumulated. This processing of accumulating the luminance signals in the coordinate range of 2×2, 3×3, or 5×5 may be called averaging in some cases. Here, accumulation is a technique of adding time-series luminance information of a coordinate close or adjacent to the coordinate (x, y) (for example, the coordinate (x+1, y+1)) to that of the coordinate (x, y) to obtain final time-series luminance information. S/N is improved by this technique. That is, the final time-series luminance information can also include the time-series luminance information of the close or adjacent coordinate(s). Further, although the coordinate (x, y) of a time-series luminance signal B(m−1, t, x, y) according to the present embodiment and the coordinate (x, y) of the time-series luminance signal B(m−1, t, x, y) are identical to each other for the sake of simplicity, the coordinate of the former signal may be a close or adjacent coordinate of that coordinate.

The signal processor 22 is configured by a logic circuit including an MPU (Micro Processing Unit), for example, and measures a distance based on a time difference between a timing at which the photodetector 17 detects the laser light L1 and a timing at which the sensor 18 detects the reflected light L2. The details of the signal processor 22 will be described later.

The output interface 23 is connected to each component in the distance measuring circuit 300 and outputs a signal to an external device such as the measurement information processing device 400.

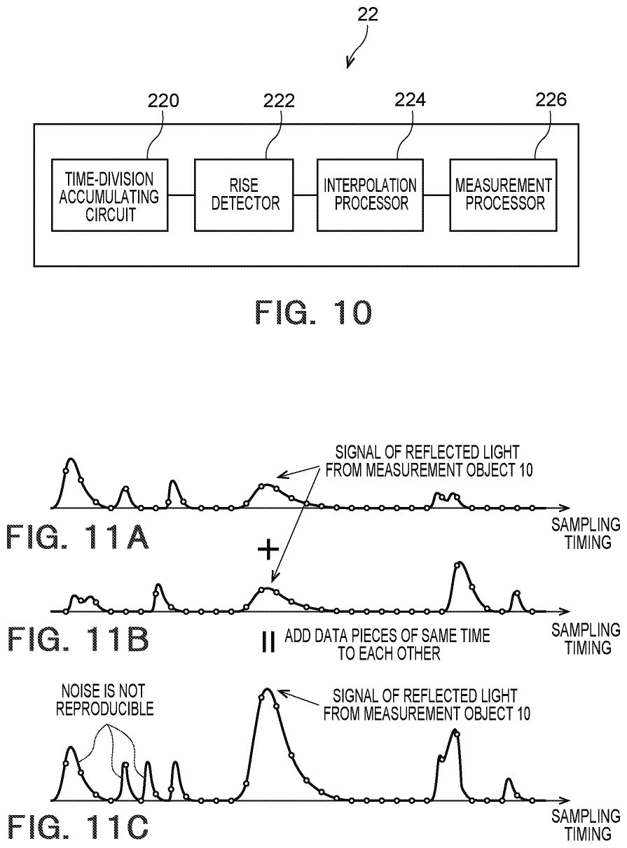

Here, a detailed configuration of the signal processor 22 is described with reference to FIG. 10. FIG. 10 is a block diagram illustrating a configuration of the signal processor 22. The signal processor 22 performs averaging (time-division accumulation) of a time-series luminance signal that is an output signal of the AD converter 21b, and detects a rise timing based on the result of averaging, thereby obtaining the distance from the measurement object 10.

The signal processor 22 includes a time-division accumulating circuit 220, a rise detector 222, an interpolation processor 224, and a measurement processor 226.

A processing example by the time-division accumulating circuit 220 is described with reference to FIG. 11 with reference to FIG. 10. The time-division accumulating circuit 220 performs time-division accumulation of a time-series luminance signal. In addition, the time-division accumulating circuit 220 has a buffer (not illustrated) and is configured to be able to store therein the time-series luminance signal. The time-division accumulating circuit 220 according to the present embodiment corresponds to an averaging processor.

FIG. 11 is an explanatory diagram of a processing example by the time-division accumulating circuit 220. FIG. 11A is a time-series luminance signal B(m, t, x, y) (t0≤t≤tk) in the current frame. The vertical axis represents a value of the luminance signal, and the horizontal axis represents a sampling timing, where k is a natural number. For example, tk=t32. Here, m (0≤m<M) represents the number of a frame f, and a coordinate (x, y) represents a coordinate determined based on the radiation direction of laser light L1(m) (0≤m<M) as described above.

FIG. 11 B is a time-series luminance signal B(m, t, x, (y+1)) (t0≤t≤tk) corresponding to an upper row in the same frame. The vertical axis represents a value of the luminance signal, and the horizontal axis represents a sampling timing.

FIG. 11 C is an average value B2(m, t)=(B(m, t, x, y)+B(m, t, x, (y+1)))/2 (t0≤t≤tk) of the time-series luminance signal B(m, t, x, y) (t0≤t≤tk) in the current frame and the time-series luminance signal B(m, t, x, (y+1)) (t0≤t≤tk) corresponding to the upper row. The vertical axis represents a value of the luminance signal, and the horizontal axis represents a sampling timing. As illustrated in FIG. 11, noise occurs at random, and signals of reflected light from the object 10 are measured at substantially the same timing. Accordingly, an S/N ratio of the time-series luminance signal B2(m, t) (t0≤t≤tk) is improved. In other words, accumulation by the time-division accumulating circuit 220 has a processing effect that is equivalent to the effect provided by expansion of the dynamic range of the sensor 18.

Although the time-series luminance signal B(m, t, x, (y+1)) (t0≤t≤tk) corresponding to the upper row is accumulated in (B), a time-series luminance signal B(m, t, x, (y−1)) (t0≤t≤tk) corresponding to a lower row may be accumulated. Alternatively, the time-series luminance signal B(m, t, x, (y+1)) (t0≤t≤tk) corresponding to the upper row and the time-series luminance signal B(m, t, x, (y−1)) (t0≤t≤tk) corresponding to the lower row may be accumulated.

Although the time-series luminance signals B in the same frame f are accumulated and averaging is performed in the example in FIG. 11, the processing is not limited thereto. For example, the time-series luminance signal B(m, t, x, y) (t0≤t≤tk) of the current frame and a time-series luminance signal B(m−1, t, x, y) (t0≤t≤tk) of a previous frame may be accumulated, and an average value B2(m, t, x, y) may be calculated as (B(m, t, x, y)+B(m−1, t, x, y))/2 (t0≤t≤tk). Also in this case, noise occurs at random, and signals of reflected light from the object 10 are measured at substantially the same timing. Accordingly, the S/N ratio of the average value B2(m, t, x, y) is improved. In a case where the influence of the random noise is smaller, the processing by the time-division accumulating circuit 220 may be omitted.

The rise detector 222 detects a rise timing of the average value B2(m, t) (t0≤t≤tk) of the time-series luminance signals. The interpolation processor 224 performs interpolation for obtaining a more accurate rise timing based on the rise timing detected by the rise detector 222 and a sampling interval of the AD converter 21b.

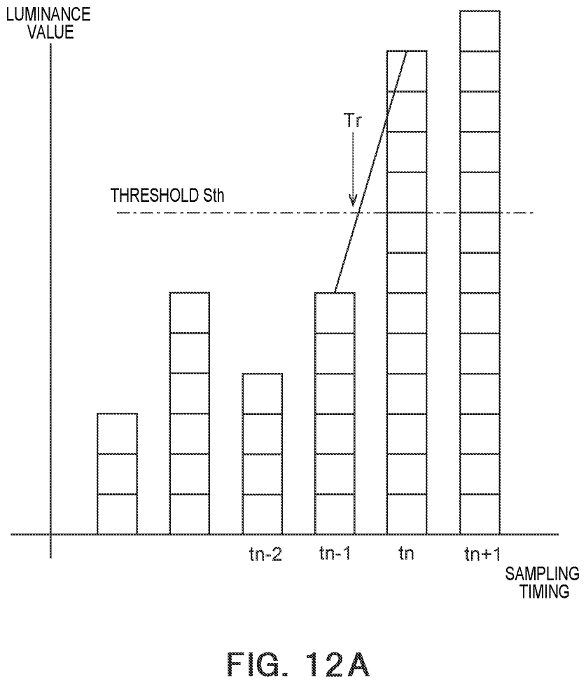

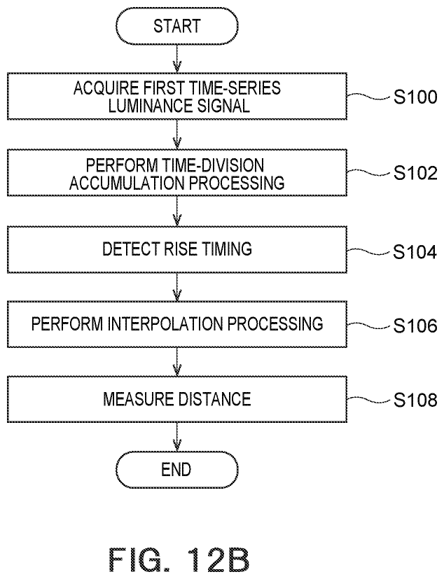

Here, a processing example by the rise detector 222 and the interpolation processor 224 is described with reference to FIG. 12A. FIG. 12A is an explanatory diagram of a processing example by the rise detector 222 and the interpolation processor 224.

The vertical axis in FIG. 12A represents a value of the average value B2(m, t) (t0≤t≤tk) of time-series luminance signals, and the horizontal axis represents a sampling timing. The rise detector 222 obtains a rise timing of the time-series luminance signal B2(m, t) (t0≤t≤tk) processed by the time-division accumulating circuit 220. More specifically, the rise detector 222 obtains a timing at which the average value B2(m, t) (t0≤t≤tk) exceeds a threshold Sth set above a noise level. As illustrated in FIG. 12A, as for the average value B2(m, t) (t0≤t≤tk), a value B2(m, tn−1) is smaller than the threshold Sth, and a value B2(m, tn) is equal to or larger than the threshold Sth. In this case, the rise detector 222 detects tn as the rise timing.

The interpolation processor 224 calculates a timing Tr at which the time-series luminance signal B2(m, t) exceeds the threshold Sth by using Equation (1) more accurately. At is a sampling interval of the AD converter 21b. Linear regression using three or more points or quadratic interpolation may be used as the interpolation by the interpolation processor 224.

Tr=tn−1+(Sth−B2(m,tn−1))/(B2(m,tn)−B2(m,tn−1))×Δt (1)

Accordingly, it is possible to obtain the rise timing Tr of the time-series luminance signal B2(m, t) (t0≤t<tk) more accurately. In a case where there is much ambient light or the like, a peak of the time-series luminance signal B2(m, t) (t0≤t<tk) becomes gentle as the signal is saturated. Therefore, assuming that a peak position is a timing at which the photodetector 17 detects the laser light L1, shift may occur depending on the shape of the peak. Meanwhile, the rise of the time-series luminance signal B2(m, t) (t0≤t<t32) is less shifted and is stable. Therefore, assuming that the rise timing Tr is the timing at which the photodetector 17 detects the laser light L1, the influence of the shape change of the peak of the time-series luminance signal B2(m, t) (t0≤t<tk) can be reduced and measurement processing can be performed stably.

The measurement processor 226 calculates a distance to the object 10 using the rise timing Tr calculated by the interpolation processor 224. That is, in the measurement processor 226, the distance is obtained by an equation “distance=speed of light×(rise timing Tr−timing of detection of laser light L1 by photodetector 17 (see FIG. 2))/2”. That is, the rise timing Tr corresponds to an elapsed time from a start time of emission of the laser light L1.

FIG. 12B is a flowchart illustrating a processing example by the distance measuring device 5 according to the present embodiment. Processing after the time-series luminance signal B(t) (t0≤t<t32) is output from the AD converter 21b is described here.

The time-division accumulating circuit 220 acquires the time-series luminance signal B(m, t, x, y) (t0≤t≤tk) of the current frame (Step S100). Subsequently, the time-division accumulating circuit 220 adds the time-series luminance signal B(m, t, x, (y+1)) (t0≤t≤tk) corresponding to an upper row stored in a buffer and the time-series luminance signal B(m, t, x, y) (t0≤t≤tk) to each other and performs averaging, thereby generating the time-series luminance signal B2(m, t, x, y) (t0≤t≤tk) (Step S102).

Next, the rise detector 222 detects the timing tn at which the time-series luminance signal B2(m, t, x, y) (t0≤t≤tk) exceeds the threshold Sth as a rise timing (Step S104).

Next, the interpolation processor 224 obtains the timing Tr at which the time-series luminance signal B2(m, t, x, y) (t0≤t≤tk) exceeds the threshold Sth based on the timing tn by using Equation (1), thereby deriving a distance result with high temporal resolution and high accuracy (Step S106).

The measurement processor 226 then calculates a distance to the object 10 using the rise timing Tr calculated by the interpolation processor 224 (Step S108). In this manner, pileup is reduced by averaging by the time-division accumulating circuit 220, so that S/N is improved. Further, since a rise timing can be detected stably even when pileup occurs, a ranging success rate is increased.

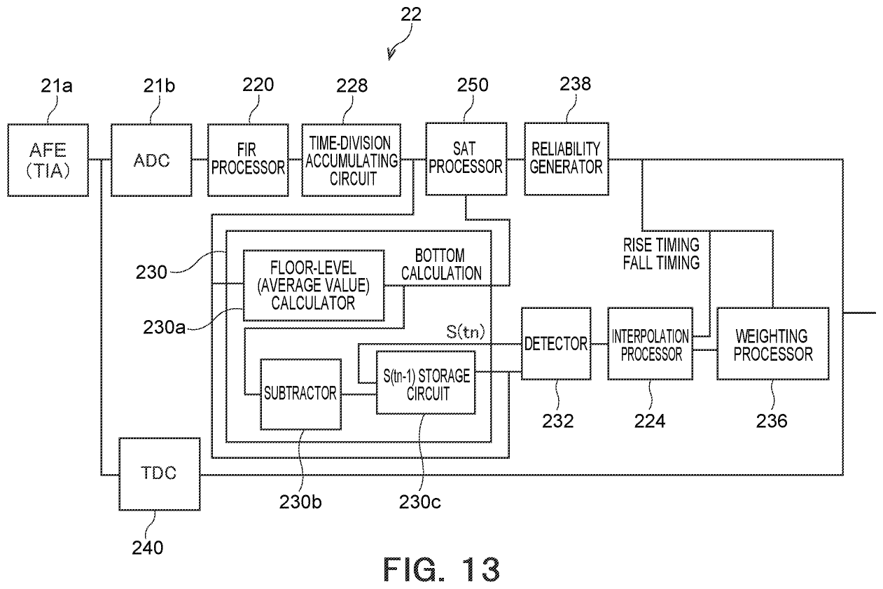

As described above, according to the present embodiment, the rise detector 222 detects the rise timing tn of the time-series luminance signal B2(m, x, y) obtained by time-division accumulation of an output signal of the AD converter 21b, and the measurement processor 226 calculates a distance based on the rise timing tn. Since the rise timing tn of the time-series luminance signal B2(m, x, y) is stable and is less shifted even in a case where saturation or pileup of the output signal of the AD converter 21b occurs, it is possible to calculate the distance to the object 10 more accurately even when there is much ambient light or the like. As for detection of a rise time, there is known a method of detecting a rise time by means of a TDC (Time to Digital Converter) by using an analog signal as an input, for example, like a TDC 240 in FIG. 13. Here, in order to obtain the rise time, it is necessary to set a threshold for detecting a rise. The threshold has to be set to be sufficiently large in order to prevent misdetection caused by noise. However, in a case where a dynamic range is not large as in an SiPM sensor, the threshold exceeds the dynamic range and detection of the rise time by the TDC becomes difficult. Further, in a case of using the TDC, averaging of the input analog signal is difficult and expansion of the dynamic range is difficult. Meanwhile, in the present embodiment, averaging is performed after conversion of an analog signal to a digital signal, whereby the problem of a lack of dynamic range is resolved. Further, because of improvement of SN by averaging, it is possible to perform distance measurement also for an object located at a long distance (>20 meters), unlike the TDC. As described above, while the problem of pileup is avoided, a ranging success rate is increased and ranging accuracy is improved.

### Second Embodiment

The driver assistance system 1 according to a second embodiment subtracts floor noise caused by ambient light to further reduce the influence of noise. Further, the driver assistance system 1 can calculate a distance, also considering a fall timing. In the following descriptions, differences from the driver assistance system 1 according to the first embodiment are explained.

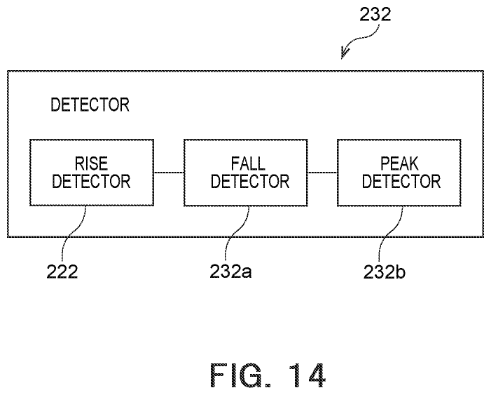

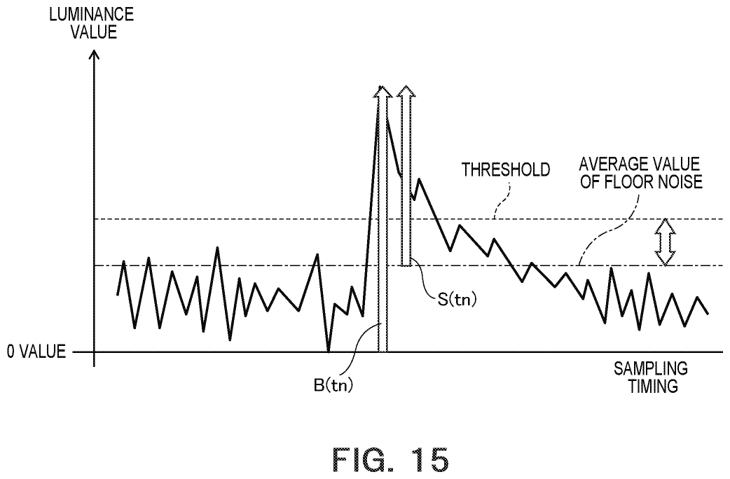

A configuration of the signal processor 22 according to the second embodiment is described with reference to FIGS. 13 and 14. FIG. 13 is a block diagram illustrating a configuration of the signal processor 22 according to the second embodiment. The block diagrams in FIGS. 13 and 14 illustrate an example of signals, and the order and the wiring are not limited thereto.

As illustrated in FIG. 13, the signal processor 22 according to the second embodiment is different from the signal processor 22 according to the first embodiment in further including an FIR processor 228, a bottom calculator 230, a detector 232, a weighting processor 236, a reliability generator 238, a TDC processor 240, and an SAT processor 250. The bottom calculator 230 includes a floor-level calculator 230a, a subtractor 230b, and a storage circuit 230c.

FIG. 14 is a block diagram illustrating a configuration example of the detector 232. As illustrated in FIG. 14, the detector 232 includes the rise detector 222, a fall detector 232a, and a peak detector 232b. The rise detector 222 has a configuration equivalent to the rise detector 222 of the signal processor 22 according to the first embodiment.

The FIR processor 228 applies FIR (Finite Impulse Response) filtering to the time-series signal B2 generated by the time-division accumulating circuit 220. The FIR processor 228 is of a filter type that smoothens the time-series signal B2. The FIR processor 228 is not limited to a filter type, as long as it has a smoothening function. The FIR processor 228 according to the present embodiment corresponds to another example of an averaging processor.

A processing example by the bottom calculator 230 is described with reference to FIG. 13. The floor-level calculator 230a detects the intensity of ambient light. The floor-level calculator 230a accumulates all luminance values during one measurement, and calculates a floor level by dividing the accumulation result by the number of times of accumulation, for example. In the present embodiment, a time-series luminance signal from ambient light may be called a floor level, floor noise, or a bottom. In addition, a period in a measurement period other than a period during which ranging is performed may be set as a period of accumulation. Alternatively, a blanking period may be set as the time period of accumulation. Accordingly, it is possible to remove a signal of reflected light from a laser and to extract contribution of ambient light only as the floor noise. The floor-level calculator calculates an average value of the floor level in this manner. The bottom calculator 230 according to the present embodiment corresponds to a noise reducing circuit.

The subtractor 230b subtracts the average value of the floor level from a luminance signal B2(tn). FIG. 15 is a diagram schematically illustrating an effect of subtraction in a case where floor noise is relatively large. The vertical axis represents a luminance value, and the horizontal axis represents a sampling timing. As illustrated in FIG. 15, the luminance signal B2(tn) simply accumulated represents a value from zero, whereas a second luminance signal S(tn) after subtraction represents a value from the average value of the floor noise.

In order to obtain a rise time, it is necessary to set a threshold for detecting the rise time. The threshold has to be set to be sufficiently large in order to prevent misdetection caused by noise. In a case where the dynamic range of a sensor cannot be set to be large, the threshold exceeds the dynamic range and detection of the rise time becomes difficult. Meanwhile, in a method of detecting a peak time, when the number of photons input to the sensor per unit time increases, saturation of a time-series luminance signal occurs in many cases, so that measurement accuracy is reduced. On the other hand, the influence of ambient light that is a source of unnecessary noise has been removed in the second luminance signal S(tn).

In the bottom calculator 230, the storage circuit 230c stores the current value S(n) in preparation for the next (tn+1). The storage circuit 230c serves as a buffer, and can store the current second luminance signal S(tn) and output the previous second luminance signal S(tn−1) simultaneously.

Subsequently, the rise detector 222 of the detector 232 receives a value of the previous second luminance signal S(tn−1) from the storage circuit 230c and a value of the second luminance signal S(tn) from the subtractor as its inputs, and determines whether S(tn−1)<threshold<S(tn) is satisfied at a rise. The threshold is a parameter given for detecting a rise time and is stored in a storage (for example, a register) (not illustrated).

Since the influence of ambient light that is the source of unnecessary noise has been removed in the second luminance signal S(tn) as described above, the second luminance signal S(tn) represents a more accurate signal value of the luminance signal B2(tn), that is, a signal in which floor noise has been removed. Therefore, even in a case where the dynamic range of the sensor 18 cannot be made large, it is possible to further reduce the probability that noise exceeds the threshold by using the second luminance signal S(tn) for measurement.

The fall detector 232a of the detector 232 detects a fall by determining whether S(tn)<threshold<S(tn−1) is satisfied after rise processing. The determination with regard to a fall is implemented by hardware that only inverts two input signals. Therefore, the rise detector 222 can also serve the fall detector 232a as hardware, so that the hardware can be downsized.

The rise detector 222 of the detector 232 and the interpolation processor 224 can perform identical processing to that in the first embodiment for the second time-series luminance signal S(t) (t0≤t≤tk), thereby calculating the rise timing Tr. In this case, noise is reduced, and the rise timing can be detected more accurately.

The fall detector 232a receives a value of the previous signal S(tn−1) from the storage circuit and a value of the signal S(tn) from the subtractor as its inputs, and determines whether S(tn)<threshold<S(tn−1) is satisfied, thereby obtaining a fall time. The interpolation processor 224 can perform identical interpolation to that in the rise detection for the signal S(t) (t0≤t≤tk) in accordance with Equation (2) to calculate a fall timing Td. Also in this case, since floor noise is reduced, it is possible to detect the fall timing Td more accurately.

Td=tn−1+(Stn−1)−Sth)/(tn−1)−S(tn))×Δt (2)

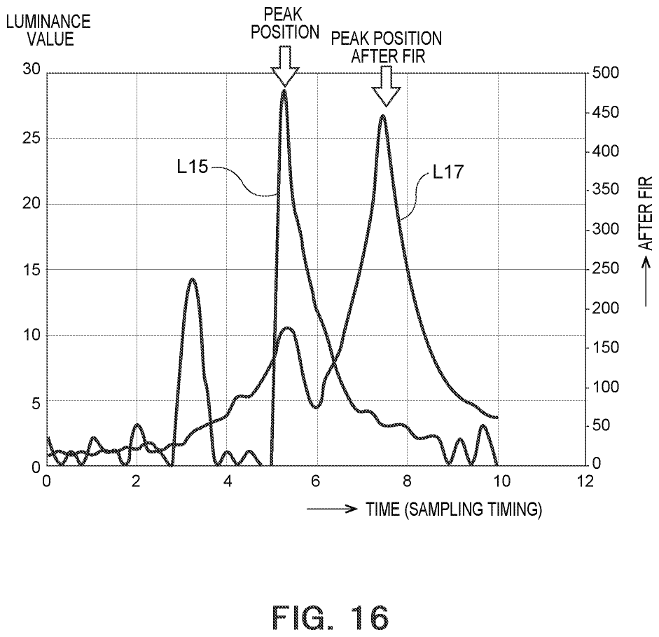

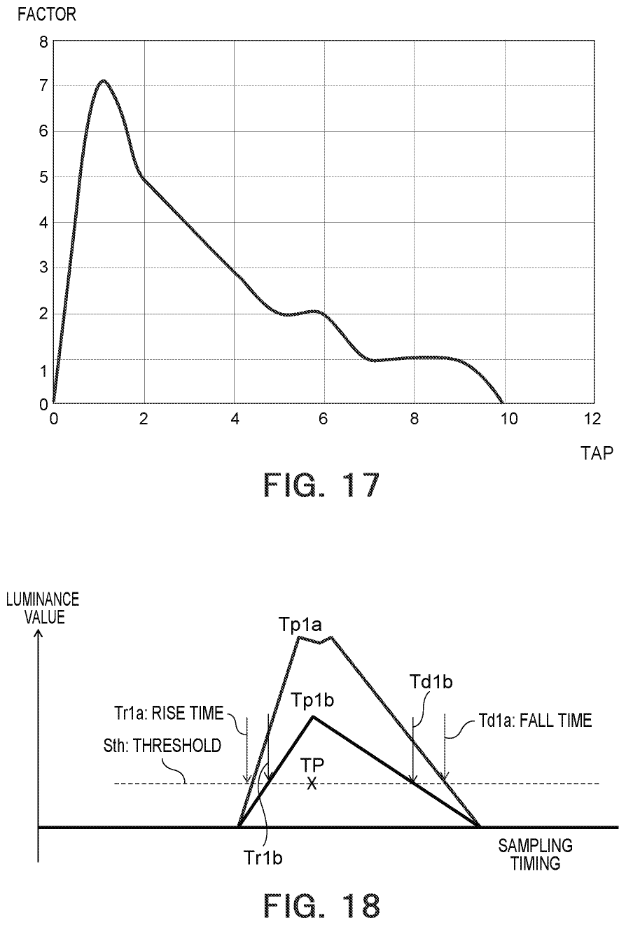

The time of a peak (a protruding portion) can be obtained by FIR filtering using the time-series luminance signal B(t) as an input. Here, processing of detecting a peak pattern in a case where FIR peak detection (peak pattern filtering) is applied is described with reference to FIGS. 16 and 17. FIG. 16 is a diagram illustrating an example of a processing result in a case where peak pattern filtering is applied. The horizontal axis represents time, and the vertical axis represents a luminance value. FIG. 17 is a diagram illustrating an example of peak pattern filtering. The horizontal axis represents the number of taps, and the vertical axis represents a filter factor. In FIG. 16, the original time-series luminance signal B2(t) (t0≤t≤tk) is denoted with a line L15 and a processed time-series luminance signal B5(t) (t0≤t≤tk) in a case where peak pattern filtering is applied is denoted with a line L17. The FIR obtains a value indicating correlation between a time-series luminance signal and a peak pattern by spending a time corresponding to the number of taps and outputs the value. Therefore, a delay that is substantially equal to the number of taps of peak pattern filtering, more precisely, a predetermined delay determined by the number of taps and a filter factor is generated. Accordingly, this delay is considered in calculation of a peak timing Tp.

The peak detector 232b obtains the peak timing Tp of the time-series luminance signal B5(t) (t0≤t≤tk) processed by peak pattern filtering, generated by a peak pattern filtering operation. The peak detector 232b is also processed in the SAT processor 250 illustrated in FIG. 13 in a case where the SAT processor 250 is provided. The SAT processor 250 is one of processes of time-division accumulation as with a time-division accumulating circuit but is more sophisticated. While the SAT processor 250 will be described later, the SAT processor 250 performs determination of similarity for adjacent pixels as accumulation objects based on similarity of a floor level and similarity of a protruding portion, and performs time-division accumulation only for time-series luminance signals with regard to the adjacent pixels that are determined as being similar to each other. The SAT processor 250 can obtain a time of a peak (a protruding portion) by processing of obtaining the maximum value.

FIG. 18 is a simplified diagram of an example of rise times Tr1a and Tr1b and fall times Td1a and Td1b of measurement signals by the detector 232. The horizontal axis in FIG. 18 represents a sampling timing and the vertical axis represents a luminance value. Here, two types of signals are illustrated which are different in the light-receiving amount from each other. The rise times Tr1a and Tr1b at each of which a corresponding measurement signal reaches the threshold Sth and the fall times Td1a and Td1b at each of which the corresponding measurement signal falls and reaches the threshold Sth after reaching the threshold Sth are illustrated with regard to the two types of measurement signals.

The weighting processor 236 calculates a timing based on a first time obtained by weighting the rise timing Tr with a first weighting factor Wr and a second time obtained by weighting the fall timing Td with a second weighting factor Wd in accordance with Equation (3), as a new peak timing TP. Values of the weights Wr and Wd are obtained by referring to a preset table. That is, the weighting processor 236 can change the values of the weights Wr and Wd in accordance with the measurement environment.

TP=Wr×Tr+Wd×Td (3)

The measurement processor 226 calculates a distance to the object 10 using the peak timing TP calculated by the weighting processor 236. That is, in the measurement processor 226, the distance is obtained by an equation “distance=speed of light×(peak timing TP−timing of detection of laser light L1 by photodetector 17 (see FIG. 2))/2”. Here, the peak timing TP corresponds to an elapsed time from a start time of emission of the laser light L1. Since the rise timings Tr1a and Tr1b and the fall timings Td1a and Td1b of the time-series luminance signal B2 are stable also in a case where an output signal of the AD converter 21b is saturated as illustrated in FIG. 18 with an upper line, the first time obtained by weighting the rise timings Tr1a and Tr1b with the first weighting factor Wr and a value obtained by weighting the fall timings Td1a and Td1b with the second weighting factor Wd and then averaging the weighted values are substantially the same value, that is TP1b. As is understood from this description, peaks (for example, Tp1a and Tp1b in FIG. 18) are shifted from each other in a case where there is significant saturation, that is, significant pileup. On the other hand, when the peak timing TP is used, it is possible to calculate the distance to the object 10 more stably even in a case where there is significant pileup. Further, the weighting processor 236 can calculate the peak timing TP using the weights Wr and Wd that are more suitable for the measurement environment by changing the values of the weights Wr and Wd in accordance with the measurement environment. Therefore, calculation accuracy of the measured distance is further improved.

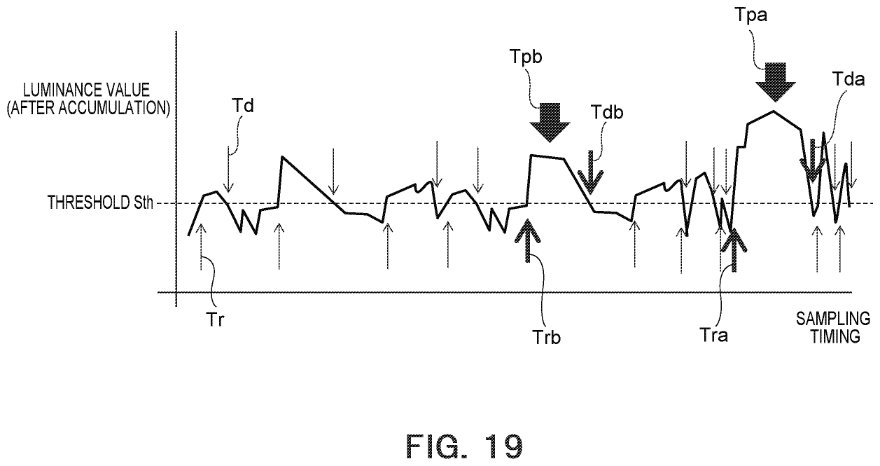

Here, a processing example by the reliability generator 238 and a distance determining circuit is described with reference to FIG. 19. FIG. 19 is a diagram illustrating a time-series luminance signal S(t, xp, yp) (t0≤t≤tk) generated by a bottom calculator. The vertical axis represents a value of the luminance signal, and the horizontal axis represents a sampling timing. Here, a coordinate (xp, yp) is a coordinate corresponding to a radiation position of the laser light L1 (see FIG. 8). FIG. 19 illustrates rise times Tr, Tra, and Trb and fall times Td, Tda, and Tdb of a measurement signal by the detector 232. Peak timings Tpa and Tpb are a peak with the highest reliability generated by the reliability generator 238 and a peak with the second highest reliability, respectively.

The reliability generator 238 calculates the reliability for each peak corresponding to the peak timing detected by the peak detector 232b. The reliability disclosed in Patent Literature 2, for example, can be used in calculation of reliability. For example, this reliability indicates the likelihood of a peak value after averaging of a time-series luminance signal S(t, x, y) (t0≤t≤tk) corresponding to the laser light L1 radiated to the surrounding of the coordinate (xp, yp) (xp−A≤x≤xp+A, yp−P≤y≤yp+A), and the reliability becomes higher as the likelihood becomes higher. For example, a case illustrated in FIG. 19 corresponds to the above description, in which the reliability of the peak denoted with Tpa and the reliability of the peak denoted with Tpb are the highest and the second highest, respectively, in the time-series luminance signal S(t, x, y) (t0≤t≤tk) (xp−A≤x≤xp+A, yp−A≤x≤yp+A).

First, the measurement processor 226 (see FIG. 10) selects the peak denoted with Tpa and the peak denoted with Tpb among many peaks based on the reliability. Subsequently, p rise times and p fall times are input from the interpolation processor 224 (or a storage (not illustrated) that stores therein the interpolation result), where p is the number of pieces of the rise time data and the fall time data that are stored in the interpolation processor 224. Tra, Trb, Tda, and Tdb are then selected to satisfy Tra<Tpa<Tda and Trb<Tpb<Tdb. Subsequently, TPa and TPb obtained by performing weighted averaging for Tra and Tda and for Trb and Tdb as described above are output as distance-value candidates. Here, although the number of pieces of output distance data is two, this number may be any number.

The detector 232 may limit information with the reliability and output it to outside. For example, the detector 232 can output information on the rise times Tra and Trb, the fall times Tda and Tdb, and the peak timings Tpa and Tpb that correspond to the peak with the highest reliability and the peak with the second highest reliability, to outside. Further, the peak detector 232b may output only information on the rise times Tra and Trb, the fall times Tda and Tdb, and the peak timings Tpa and Tpb to the interpolation processor 224 and the weighting processor 236 in subsequent stages. With this configuration, the processing speed is increased. Furthermore, the detector 232 may output the reliability of a peak generated by the reliability generator 238 and the rise time Tra and the fall time Tda corresponding to this peak in association with each other. Similarly, the detector 232 may output the reliability of a peak generated by the reliability generator 238 and the rise time Trb and the fall time Tdb corresponding to this peak in association with each other.

As described above, the detector 232 sets the rise time Tr that is the closest in time to the peak timing Tpa as the rise time Tra and sets the fall time Td that is the closest in time to the peak timing Tpa as the fall time Tda. Similarly, the detector 232 sets the rise time Tr that is the closest in time to the peak timing Tpb as the rise time Trb and sets the fall time Td that is the closest in time to the peak timing Tpb as the fall time Tdb. Accordingly, accuracy of selecting the rise times Tra and Trb and the fall times Tda and Tdb is further improved. As described above, use of the reliability can further improve measurement accuracy, and use of a rise time and a fall time can remove the influence of saturation, that is, pileup. In the present embodiment, an average value of floor noise is subtracted from a time-series signal, and a rise time is detected based on a magnitude relation between the subtraction result and a threshold. Instead, the average value of floor noise may be added to a threshold, and a rise time may be detected based on a magnitude relation between a time-series signal and the addition result.

The TDC processor 240 includes, for example, a time to digital converter (TDC). The time to digital converter measures a rise timing Tdcup at which a signal of the laser light L1 exceeds a second threshold Sth2 after emission of the laser light L1. That is, the TDC processor 240 acquires the rise timing Tdcup at which a time-series luminance signal obtained by converting reflected light of laser light to a signal reaches the second threshold Sth2. The measurement processor 226 calculates a distance to the object 10 using the rise timing Tdcup generated by the TDC processor 240. That is, in the measurement processor 226, the distance is obtained by an equation “distance=speed of light×(rise timing Tdcup−timing of detection of laser light L1 by photodetector 17 (see FIG. 2))/2”.

In the TDC processor 240, measurement accuracy is reduced in a case where the distance to an object is long. However, the TDC processor 240 can return a more accurate result in a case where the distance to the object is short. That is, the TDC processor 240 can be used as a short-distance measuring device.

As described above, according to the present embodiment, the bottom calculator 230 reduces floor noise that is ambient light noise from the time-series luminance signal B2(t) (t0≤t≤tk) generated by the time-division accumulating circuit 220, to generate the second time-series luminance signal S(t) (t0≤t≤tk). Accordingly, for the time-series luminance signal B2(t) (t0≤t≤tk) of which dynamic range is expanded by the time-division accumulating circuit 220, it is possible to generate the second time-series luminance signal S(t) (t0≤t≤tk) in which the floor noise that is a component of reducing the dynamic range has been reduced by the bottom calculator 230. Therefore, also in a case where the time-series luminance signal B(t) (t0≤t≤tk) is saturated because of ambient light or the like, it is possible to reduce the influence of saturation by using the second time-series luminance signal S(t) (t0≤t≤tk), so that more stable distance measurement can be performed.

Further, also in a case where the time-series signal B(t) (t0≤t≤tk) is saturated because of ambient light or the like and the top of the peak collapses, it is possible to stably perform ranging by detecting a rise and a fall in place of detecting the peak. In this case, by using the second time-series luminance signal S(t) (t0≤t≤tk), a rise and a fall can be detected while the influence of saturation is more reduced, so that accuracy of detection of the rise and the fall is further improved. Accordingly, the drawback of an SiPM, that is, the influence of pileup can be reduced, and a ranging method more suitable for the SiPM can be established. As described above, in general, detection of the rise and fall times is influenced by the floor noise based on ambient light. However, since the floor noise based on ambient light is subtracted by using the second time-series luminance signal S(t) (t0≤t≤tk) in the present embodiment, detection is hardly influenced by ambient light and stable ranging can be performed. Further, since the reliability based on a peak is also used, it is possible to perform ranging with higher likelihood and a higher success rate.

### (Modification of Second Embodiment)

In the driver assistance system 1 according to a modification of the second embodiment, a threshold for detecting a rise and a fall is obtained based on floor noise, whereby the influence of the floor noise is further reduced. This driver assistance system 1 is different from the driver assistance system 1 according to the second embodiment in that the floor-level calculator 230a illustrated in FIG. 13 can detect not only the average value of floor noise but also the maximum value of the floor noise. In the following descriptions, differences from the driver assistance system 1 according to the second embodiment are explained.

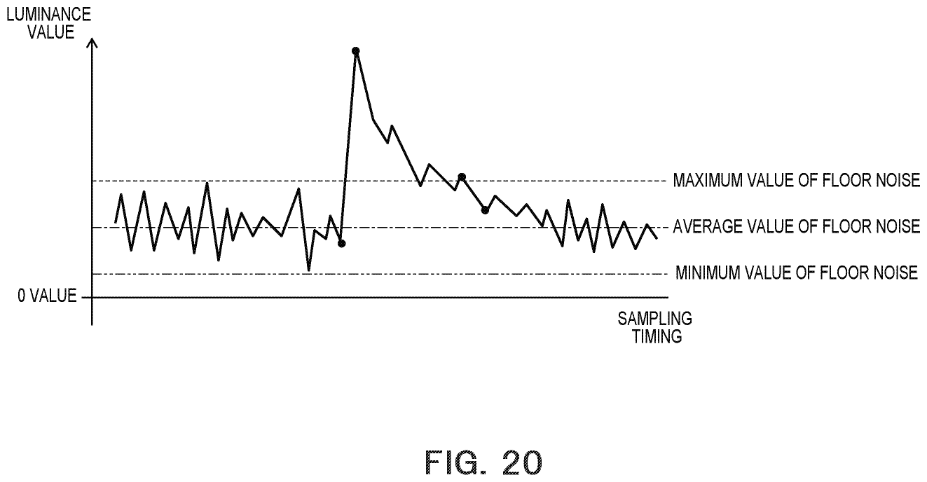

FIG. 20 is a schematic diagram for explaining an example in which an average value of floor noise is subtracted from the maximum value of floor noise to obtain a threshold. A long-dashed short-dashed line in FIG. 20 represents the average value of floor noise and a dotted line denotes the maximum value of floor noise. The distance between the long-dashed short-dashed line and the dotted line in FIG. 20 corresponds to a threshold. More specifically, the detector 232 obtains the maximum value with regard to a period in a period for one measurement, other than a period during which ranging is performed, or with regard to a blanking period. With this operation, it is possible to remove a signal of reflected light from a laser and to detect the maximum value of ambient light only. The detector 232 then sets the result obtained by subtracting an average value from the thus obtained maximum value as a threshold Sthn. As illustrated in FIG. 20, floor noise does not rise beyond the dotted line, and there is no risk of mismeasurement of noise. Further, the detector 232 calculates a correction result Ctr of a rise time by adding a correction value Csth (kr×Sthn) that is in proportion to the magnitude of the threshold Sthn to the obtained rise time Tr by using Equation (4), for example.

Ctr=Tr+kr×Sthn (4)

Further, the detector 232 also calculates a correction result Ctd of a fall time by adding the correction value Csth (kr×Sthn) that is in proportion to the magnitude of the threshold Sthn to an obtained fall time in an identical manner.

As described above, in the driver assistance system 1 according to the modification of the second embodiment, the detector 232 dynamically generates the threshold Sthn in accordance with the magnitude of ambient light. Further, when the threshold Sthn becomes larger for the second time-series luminance signal S(t) (t0≤t≤tk), a rise time is calculated as the correction result Ctr obtained by delaying the rise time, as represented by Equation (4). With this correction, variation of the rise time caused by change of the threshold Sthn is prevented, so that accuracy is further improved. Since this threshold Sthn does not contain an average value of the floor level, the correction value Sthn does not become excessively large.

### Third Embodiment

The driver assistance system 1 according to a third embodiment is obtained by replacing the time-division accumulating circuit 220 in the first and second embodiments with the SAT processor 250. The SAT processor 250 reduces noise by performing accumulation based on similarity between luminance signals obtained by radiation to adjacent radiation directions. In the following descriptions, differences from the driver assistance system 1 according to the first embodiment are explained.

The driver assistance system 1 according to the third embodiment uses a light source that intermittently emits laser light a plurality of times to a first radiation direction and a second radiation direction and generates, based on similarity between a first digital signal corresponding to laser light radiated to the first direction from the light source most recently and a plurality of second digital signals for the plural radiations, a plurality of weight values for the second digital signal. The driver assistance system 1 then generates a third digital signal obtained by weighting the first digital signal corresponding to the laser light radiated to the first direction from the light source most recently with the second digital signals with weight values, as a time-series luminance signal B1(t) (t0≤t≤tk). The SAT processor 250 according to the present embodiment corresponds to an averaging processor.

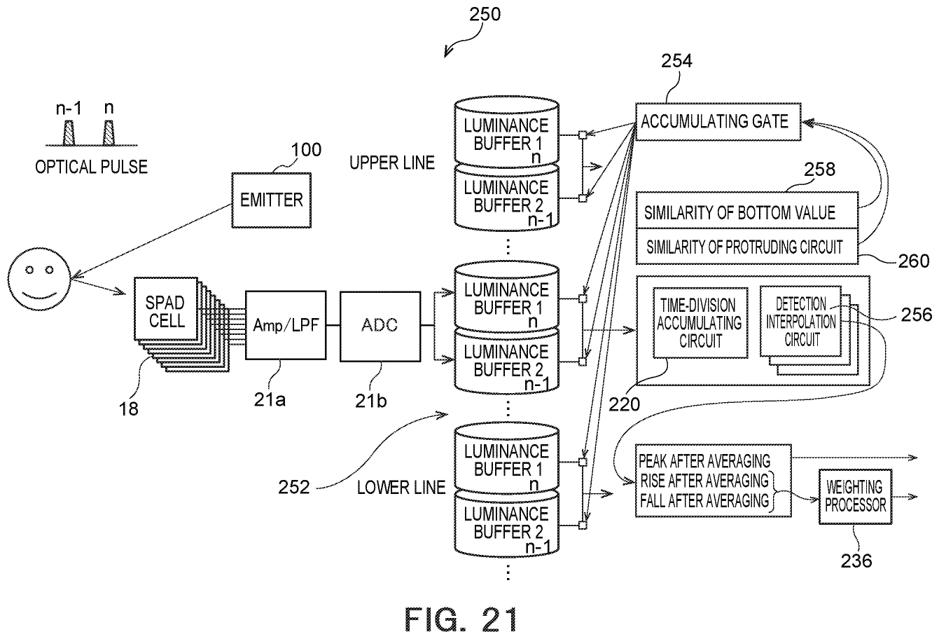

FIG. 21 is a diagram schematically illustrating a configuration of the distance measuring device 5 according to the third embodiment. The SAT processor 250 includes a buffer 252, an accumulating gate 254, a detection interpolation circuit 256, and the time-division accumulating circuit 220 having a processing function equivalent to that in the first embodiment. The SAT processor 250 obtains a floor level and the magnitude of a protruding portion (a peak of a time-series luminance signal) with regard to adjacent pixels present in an accumulation range, and determines whether to accumulate time-series signals of the adjacent pixels based on the correlation.

Since it is unclear whether to accumulate the time-series signals, it is necessary to temporarily store them. Thus, the luminance buffers 252 are included as storages for that purpose, the number of which is equal to the number of the adjacent pixels in the accumulation range. The magnitude of the aforementioned correlation indicates whether an object located in the direction of an adjacent pixel is the same as an object located at a pixel of interest. Reflected light from the same object is a signal, whereas reflected light from a different object is noise. Not accumulating a time-series signal of an adjacent pixel with low correlation means removing reflected light that is highly likely to be noise, and leads to improvement of an SN ratio.

First, as illustrated in FIG. 21, a time-series signal generated by AD conversion is stored in the luminance buffer 252 as described before. After one measurement is ended, the detection interpolation circuit 256 receives inputs from the luminance buffers 252 and obtains an average value of a floor level and a plurality of peak values for all pixels in the accumulation range. Thereafter, a bottom similarity circuit 258 that obtains similarity of bottom value determines the degree of similarity of floor level value with respect to each adjacent pixel. Further, a protrusion similarity circuit 260 that obtains similarity of protruding portion determines the degree of similarity of peak value with respect to each adjacent pixel. The accumulating gate 254 sends a time-series signal of an adjacent pixel determined as having high similarity to the time-division accumulating circuit 220 selectively, and the time-division accumulating circuit 220 performs time-division accumulation. The detection interpolation circuit 256 detects a floor level again for the result of time-division accumulation, subtracts the detection result from the result of time-division accumulation, and detects a rise and a fall based on a magnitude relation between the previous result and a threshold, thereby performing interpolation. The processing by the detection interpolation circuit 256 is equivalent to that performed by the bottom calculator 230, the detector 232, and the interpolation processor 224 in the second embodiment.

In the present embodiment, by applying the SAT processor 250, the protrusion similarity circuit 260 that obtains similarity of protruding portion determines the degree of similarity of peak value with respect to each adjacent pixel, a signal of a pixel that is highly likely to be noise is not accumulated, and an SN ratio of the time-series luminance signal B1(t) (t0≤t≤tk) becomes higher. Therefore, it is possible to perform more accurate distance measurement with less noise by using that time-series luminance signal B1(t) (t0≤t≤tk) for measurement. Further, in a case where ambient light is strong, the bottom similarity circuit 258 of the SAT processor 250 determines the degree of similarity of floor level value with respect to each adjacent pixel, a signal of a pixel that is highly likely to be floor noise is not accumulated, and a time-series signal based on ambient light (floor noise) is removed. Therefore, saturation of a signal value, that is, pileup can be prevented, and robust ranging can be performed. Furthermore, a spatial resolution is reduced by averaging, in general. However, in a case of using the SAT processor 250, the accumulating gate 254 selectively sends a time-series signal of an adjacent pixel determined as having higher similarity to the time-division accumulating circuit 220, and the time-division accumulating circuit 220 performs time-division accumulation. Therefore, resolution reduction can be prevented. Accordingly, it is possible to improve ranging performance such as a ranging success rate and distance accuracy, while the resolution is maintained.

### Fourth Embodiment

The driver assistance system 1 according to a fourth embodiment is configured to allow the emitter 100 to change an emission timing in each emission. In the following descriptions, differences from the driver assistance system 1 according to the second embodiment are explained.

More specifically, for example, regarding even-numbered (2n-th, n is an integer) emission and odd-numbered ((2n+1)th) emission, the emitter 100 (see FIG. 2) advances the emission timing of the even-numbered emission by half a sampling time by the AD converter 21b (see FIG. 2). The signal processor 22 then superposes the even-numbered (2n-th) and odd-numbered ((2n+1)th) time-series signals on each other alternatively.

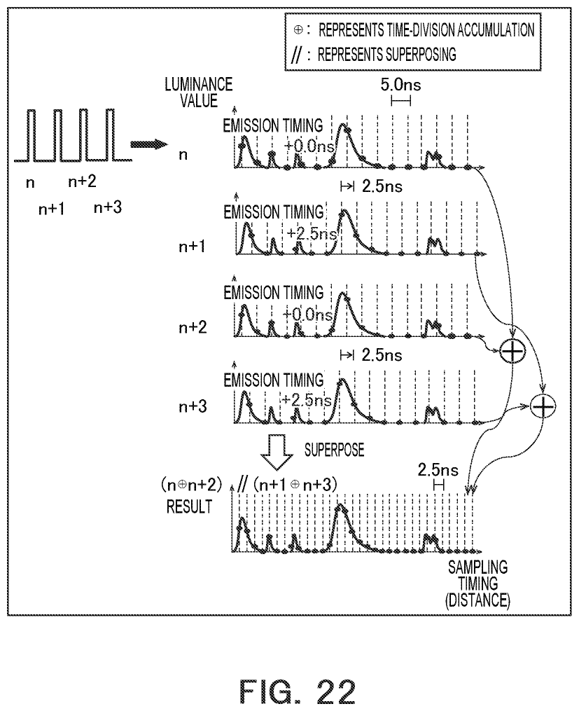

FIG. 22 is a diagram schematically illustrating timings of even-numbered (2n-th, n is an integer) emission and odd-numbered ((2n+1)th) emission and superposing of time-series luminance signals of those emissions. The left diagram illustrates emission timings n to n+3 of the emitter 100. The right diagram illustrates time-series luminance signals corresponding to the emission timings n to n+3, respectively. The vertical axis represents a luminance value, and the horizontal axis represents a sampling timing. Noise is omitted in FIG. 22 for simplifying the descriptions.

As described above, an even-numbered (2n-th) emission timing of the emitter 100 is advanced from an odd-numbered ((2n+1)th) emission timing of the emitter 100 by half a sampling time. Therefore, in a time-series signal generated by sampling by the AD converter 21b, even-numbered (2n-th) time-series signals and odd-numbered ((2n+1)th) time-series signals are shifted from each other by half the sampling time.

Accordingly, when the shift is eliminated and the even-numbered (2n-th) time-series signals and the odd-numbered ((2n+1)th) time-series signals are added to each other to correspond to the emission timings of the emitter 100, the number of data pieces is doubled and a sampling interval is equivalent to half the sampling interval of the AD converter 21b. This result of superposing is functionally coincident with sampling by the AD converter 21b at an interval of (Δt/2) that is half a sampling time Δt. For a time-series luminance signal B(m, t) (t0≤t≤tk×2) in which the number of data pieces has been doubled, averaging is performed, a rise time and a fall time are obtained, and the distance to an object is obtained, as in the second embodiment.

In general, the temporal resolution of the AD converter 21b is inferior to the temporal resolution of a TDC. Although a rise time or the like is increased by orders of magnitude by the interpolation and accuracy is improved, there is a limit to improvement of the accuracy because of various factors and the accuracy is inferior to the accuracy of the temporal resolution of the TDC. As described above, it is not easy to improve the temporal resolution of the AD converter 21b without increasing the power consumption or the size thereof. However, the method of the present embodiment can obtain a result in which a sampling time is half apparently without improving the temporal resolution of the AD converter 21b, and can improve distance accuracy.

As described above, according to the present embodiment, it is possible to apparently double the temporal resolution of the AD converter 21b by change of an emission timing by the emitter 100. Accordingly, the time-series luminance signal B(m, t) (t0≤t≤tk×2) in which the number of data pieces has been doubled can be used, so that accuracy of distance measurement can be made higher.

While certain embodiments have been described, these embodiments have been presented by way of example only, and are not intended to limit the scope of the inventions. Indeed, the novel embodiments described herein may be embodied in a variety of other forms and various omissions, substitutions, and changes may be made without departing from the spirit of the inventions. The embodiments and their modifications are intended to be included in the scope and the spirit of the invention and also in the scope of the invention and their equivalents described in the claims.

1. A distance measuring device comprising:
an averaging processor configured to average a digital signal obtained by digitizing reflected light of laser light and generate a time-series luminance signal;
a detector configured to detect a rise time at which the time-series luminance signal reaches a threshold; and
a distance measuring circuit configured to measure a distance to an object based on a time difference between the rise time and a radiation timing of the laser light.

2. The device of claim 1, further comprising a noise reducing circuit configured to reduce floor noise corresponding to an intensity of ambient light from the time-series luminance signal, wherein
the time-series luminance signal in the detector is a time-series luminance signal from which the floor noise has been reduced.

3. The device of claim 2, wherein the noise reducing circuit calculates the floor noise based on a digital signal digitized in either a period in which the laser light is not radiated or a blanking period when the digital signal is generated.

4. The device of claim 1, wherein the averaging processor averages a plurality of time-series digital signals to generate the time-series luminance signal.

5. The device of claim 1, wherein the averaging processor averages a plurality of time-series digital signals based on similarity between them to generate the time-series luminance signal.

6. The device of claim 1, wherein the averaging processor averages a plurality of time-series digital signals based on similarity of at least either a floor noise level or a peak position between them to generate the time-series luminance signal.

7. The device of claim 4, wherein the time-series digital signals correspond to laser light radiated to different directions or laser light radiated at different timings, respectively.

8. The device of claim 1, further comprising an interpolation processer configured to generate a more accurate rise time by interpolation using a value of a luminance signal at a timing at which the time-series luminance signal exceeds the threshold, a value of a luminance signal at a time before the timing by a time equal to one sampling interval in digitizing, and a time equal to the one sampling interval, wherein
the distance measuring circuit measures a distance by using a rise time generated by the interpolation processor.

9. The device of claim 1, wherein the detector further detects, for the time-series luminance signal in which the noise has been reduced, a fall time at which that signal falls below the threshold after reaching the threshold.

10. The device of claim 9, wherein the detector sets the threshold in accordance with a floor noise level.

11. The device of claim 10, wherein the detector corrects a rise time and a fall time in accordance with the threshold.

12. The device of claim 9, wherein for the time-series luminance signal, the detector detects a peak, detects the rise time corresponding to a time before the peak, and detects the fall time corresponding to a time after the peak.

13. The device of claim 9, wherein the detector outputs a plurality of combinations of at least two pieces of information among the peak detection, the rise time corresponding to the peak detection, and the fall time corresponding to the peak detection.

14. The device of claim 9, further comprising a weighting processor configured to perform weighting for the rise time and the fall time to generate a second timing, wherein
the distance measuring circuit measures a distance by using the second timing.

15. The device of claim 14, further comprising a reliability generator configured to generate reliability of a peak of the time-series luminance signal, wherein
the rise time and the fall time that correspond to the peak, and the reliability are associated with each other.

16. The device of claim 1, further comprising:
a radiation optical system configured to radiate the laser light to a measurement object while changing a radiation direction of the laser light;
a light-receiving optical system configured to receive a reflected light of the laser light radiated from the radiation optical system;
a sensor configured to convert reflected light received through the light-receiving optical system to an electric signal; and
an AD converter configured to convert an electric signal output from the sensor to the digital signal.

17. The device of claim 16, wherein the sensor is configured by silicon photomultipliers.

18. A distance measuring method comprising:
averaging a digital signal obtained by digitizing reflected light of laser light to generate a time-series luminance signal;
detecting a rise time at which the time-series luminance signal reaches a threshold; and
measuring a distance to an object based on a time difference between the rise time and a radiation timing of the laser light.
